(19) United States
(12) Patent Application Publication
(10) Pub. No.: US 2009/0281978 A1
(43) Pub. Date: Nov. 12, 2009

(54) SYSTEMS AND METHODS FOR INTEGRATING USER-GENERATED CONTENT WITH PROPRIETARY CONTENT IN A DATABASE

(75) Inventors: Mark Gordon, Indianapolis, IN (US); Kevin McCurry, Winchester, MA (US)

Correspondence Address: EDWARDS ANGELL PALMER & DODGE LLP, P.O. BOX 55874, BOSTON, MA, 02205, US

(73) Assignee: Thomson Reuters Global Resources

(21) Appl. No.: 12/435,116

(22) Filed: May 4, 2009

Related U.S. Application Data
(60) Provisional application No. 61/050,486, filed on May 5, 2008.

(51) Int. Cl. G06N 7/02; G06F 3/048; G06F 17/30

(52) U.S. Cl. 706/52; 715/751; 707/100; 707/E17.044; 715/764

(57) ABSTRACT

A system for managing and displaying collaborative content in a database. The database is configured to store both editor-generated content and user-generated content. The system also includes a server interfacing with the database, a display device connected to the server, a editor content module interfacing with the database and configured to display the editor-generated content on the display device, a user interface module running on the sever, a user content module configured to receive the user input from the user interface module and display the user input as user-generated content on the display device, a validation module interfacing with the user content module, wherein the validation module is configured to verify the accuracy of the user-generated content, and a bias detection module interfacing with the user content module, wherein the bias detection module is configured to detect bias in the user-generated content.

### CROSS REFERENCE TO RELATED APPLICATION

This application claims priority to U.S. Provisional Patent Application No. 61/050,486 filed May 5, 2008, the contents of which are incorporated herein by reference.

### BACKGROUND OF THE INVENTION

1. Field of the Invention

The present invention is directed to systems and methods for integrating user-generated content into a proprietary database. More specifically, the present invention involves collecting, validating, and managing user-generated content and integrating the user-generated content with editor-generated content in a proprietary database, such as a pharmaceutical database. The present invention is also directed to systems and methods for facilitating collaboration with regard to the information in the database.

2. Background of the Related Art

The Internet has facilitated communication and collaboration on a level unheard of just a few years ago. Recent developments have allowed companies and individuals to harness the collective intelligence provided by thousands and even millions of individual users to create rich repositories of interconnected information that can be used to provide enhanced information, products, and services to those same users.

This movement to harness collective intelligence on the Internet has been termed Web 2.0. The heart of Web 2.0 is collaboration and interconnectivity, allowing individual users to share, tag, link to, comment on, remix, and otherwise use information in ways that may not have even been contemplated by the original authors of the content. This collaboration and interconnectivity amplifies the usefulness of the content and provides users with a richer experience. Many web-based applications use blogs, wikis, social-networking, and other collaborative tools to allow users to share, link, and comment on photos, text, music, videos, and almost any other form of information. These collaborative tools foster formation of online communities whose growth amplifies the usefulness of the information that is provided to all users.

The downside of increased interconnectivity and collaboration is an increase in the noise and disinformation that inevitably forms a part of an open community. The challenge is to filter out the noise while still harnessing the collective intelligence to increase the usefulness and timeliness of the information. For a web application to truly be useful, it is necessary to motivate users to participate and to provide the type of information that will enhance, rather than detract from, the information that is being presented.

Although verifying accuracy and lack of bias may not be necessary or even desirable for certain social networking applications, these concerns are critical for the success of a web application dealing with specific specialized or technical topics such as pharmaceuticals. For these specialized applications, it is especially important to motivate experts in the field to participate by generating and reviewing content that then can be used to enhance the web application. Additionally, it is essential to have a method of efficiently validating user-created content and determining the reliability of that content.

### SUMMARY OF THE INVENTION

Advantages of the present invention will be set forth in and become apparent from the description that follows. Additional advantages of the invention will be realized and attained by the methods and systems particularly pointed out in the written description and claims, as well as from the appended drawings.

To achieve these and other advantages and in accordance with the purpose of the invention, as embodied herein, the invention includes a system for managing and displaying collaborative content in a database. The database is configured to store both editor-generated content and user-generated content. The system also includes a server interfacing with the database, a display device connected to the server, a editor content module interfacing with the database and configured to display the editor-generated content on the display device, a user interface module running on the sever, a user content module configured to receive the user input from the user interface module and display the user input as user-generated content on the display device, a validation module interfacing with the user content module, wherein the validation module is configured to verify the accuracy of the user-generated content, and a bias detection module interfacing with the user content module, wherein the bias detection module is configured to detect bias in the user-generated content. The user interface module is configured to receive input from a user and to display content from the database on the display device.

A computer-implemented method of managing and displaying collaborative content is also provided. The method includes the steps of providing a database storing editor-generated content and user-generated content, providing a server interfacing with the database, providing a display device connected to the server, receiving input in the form of user-generated content from a user, validating the accuracy of the user-generated content using the server, detecting the presence of potential bias in the user-generated content using the server, and displaying the editor generated content and the user-generated content together on the display device. The display of the user-generated content includes an indication of the probability of accuracy and the probability of bias.

### BRIEF DESCRIPTION OF THE DRAWINGS

So that those skilled in the art to which the subject invention pertains will readily understand how to implement the systems and methods for integrating user-generated content with proprietary content in a database, without undue experimentation, preferred embodiments of the system and methods will be described in detail below with reference to the following figures:

FIG. 1 is a schematic illustration of the system for integrating user-generated content with proprietary content in a database, as set forth in the present disclosure;

FIG. 2 is an exemplary embodiment of a portion of the user interface of the system, illustrating a drug report page that includes a contribute button allowing a user to submit information to be included in the drug report;

FIG. 3 is an exemplary embodiment of a portion of the user interface of the system, illustrating an interactive form allowing a user to contribute information to various data fields in the drug report page of FIG. 2;

FIG. 4 is an exemplary embodiment of a portion of the user interface of the system, illustrating an edit menu that allows a user to selectively determine the contribution level or attribution given to submissions made by the user and to decide which group of other users will be able to view the submissions;

FIG. 5 is an exemplary embodiment of a portion of the user interface of the system, illustrating a text editing window that allows a user to enter comments regarding the information present in the drug report page shown in FIG. 2; and

FIG. 6 is an exemplary embodiment of a portion of the user interface of the system, illustrating how comments entered by a user would be seen on the drug report page shown in FIG. 2.

### DETAILED DESCRIPTION OF PREFERRED EMBODIMENTS

Reference will now be made in detail to the present preferred embodiments of the systems and methods for integrating user-generated content with proprietary content in a database. In one exemplary embodiment, the system comprises a system for collecting, managing, and validating user-generated content and integrating that content into a comprehensive proprietary pharmaceutical database, such as the Thomson Pharma® database available from Thomson Reuters. Thomson Pharm® is a comprehensive global pharmaceutical information solution that covers the entire drug discovery and development pipeline. The database includes competitive intelligence and strategic data to facilitate more focused collaboration and to encourage innovation. Although the examples given below relate to a pharmaceutical database, those skilled in the art will readily appreciate that the systems and methods disclosed can be used for managing and facilitating collaboration in a wide variety of databases.

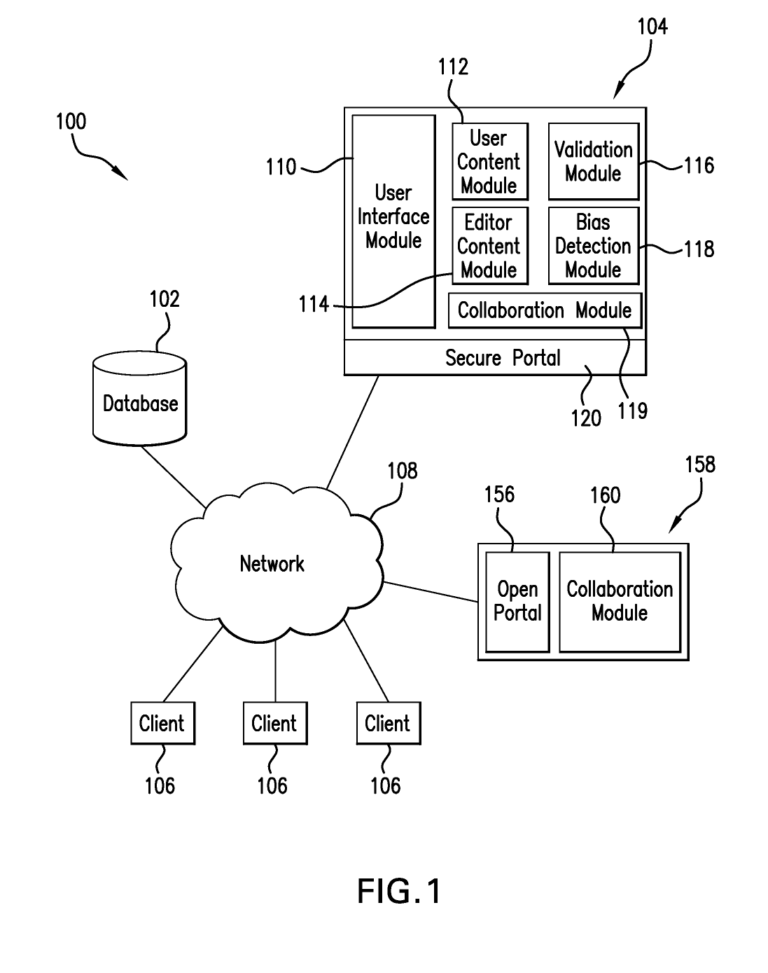

For purposes of explanation and illustration, and not limitation, an exemplary embodiment of a system in accordance with the present invention is shown in FIG. 1 and designated generally by the reference numeral 100. System 100 includes a database 102, a server computer 104, and a plurality of client devices 106. Database 102, server 104, and clients 106 interface with one another via a network 108. Network 108 may be any suitable network, including a company intranet or other local area network, a wide area network, and the Internet. Server 104 may include a plurality of servers, and database 102 may include a plurality of databases. Clients 106 may include a computer, a mobile phone, or any other network-enabled device.

System 100 may comprise software components running on either server 104 or clients 106. Server 104 and clients 106 may run any suitable operating system and may include a variety of hardware configurations. Both server 104 and clients 106 may include a processor coupled to a memory module and to a mass storage device via a bus or other communication medium; a display or other output device interfacing with the processor; and a keyboard, mouse, touchpad, or other input device that receives input from a user and interfaces with the processor. In one exemplary embodiment, client computers 106 each include an input device for receiving user input and a display device for displaying content. The software implementing system 100 may include instructions written in a high level computer language and stored in a mass storage device.

As shown in FIG. 1, server 104 may include a user interface module 110, a user content module 112, an editor content module 114, a validation module 116, and a bias detection module 118. Alternatively, user interface module 110, user content module 112, editor content module 114, validation module 116, and bias detection module 118 may run on clients 106 on a plurality of different servers, or a combination of both.

In one exemplary embodiment, database 102 is a proprietary database, such as Thomson Pharma®, providing a comprehensive pharmaceutical database with in-depth information regarding millions of unique chemical structures, thousands of drug monographs, millions of unique gene sequences, and thousands of biologically-relevant drug targets. Database 102 may also contain information on new drugs and compounds, clinical trials and deals, and the latest journals, conferences, academic articles and abstracts, and medical news stories. Database 102 may also include in-depth competitive intelligence, including information on millions of basic inventions and patents with detailed pipeline, financial, and marketing profiles for thousands of companies. All of the information in database 102 may be cross referenced and indexed so that it will be readily accessible to a user of system 100.

Using a client computer 106, a user may gain access to database 102 through user interface module 110. User interface module 110 may include a secure portal 120 providing the user with access to at least a portion of the contents of database 102 via network 108. Access to database 102 via secure portal 120 may require authentication, using a user name and password or by other suitable means. Additionally, each user may have a user profile stored within the system that includes the user's name, title, and employer. The user profile may also include additional information such as each user's educational history, work history and any other suitable information. This information may be provided voluntarily by the user or may be required as part of a subscription process to gain access to database 102.

In one exemplary embodiment, access to the contents of database 102 is available by subscription only, requiring authentication through secure portal 120. Because motivating interested parties to participate in the generation of content can be a challenge, the present invention contemplates motivating small companies, for example, small biotech companies, to participate by providing free limited access to database 102. A small company may be granted access only to that portion of database 102 that concerns their company and their company's products. The small company will be motivated to contribute user-generated content to keep their information as up to date as possible, since small companies are likely to want larger companies to in-license the drugs and technology owned by the smaller company.

Additionally, users from small consulting firms and from academia, as well as other scientific and commercial experts who may be involved in the pharmaceutical field but who may not be able to readily afford a subscription to database 102 may be granted access to the database at a reduced price or for free to encourage these experts to contribute content that will enhance the value of the information available in database 102.

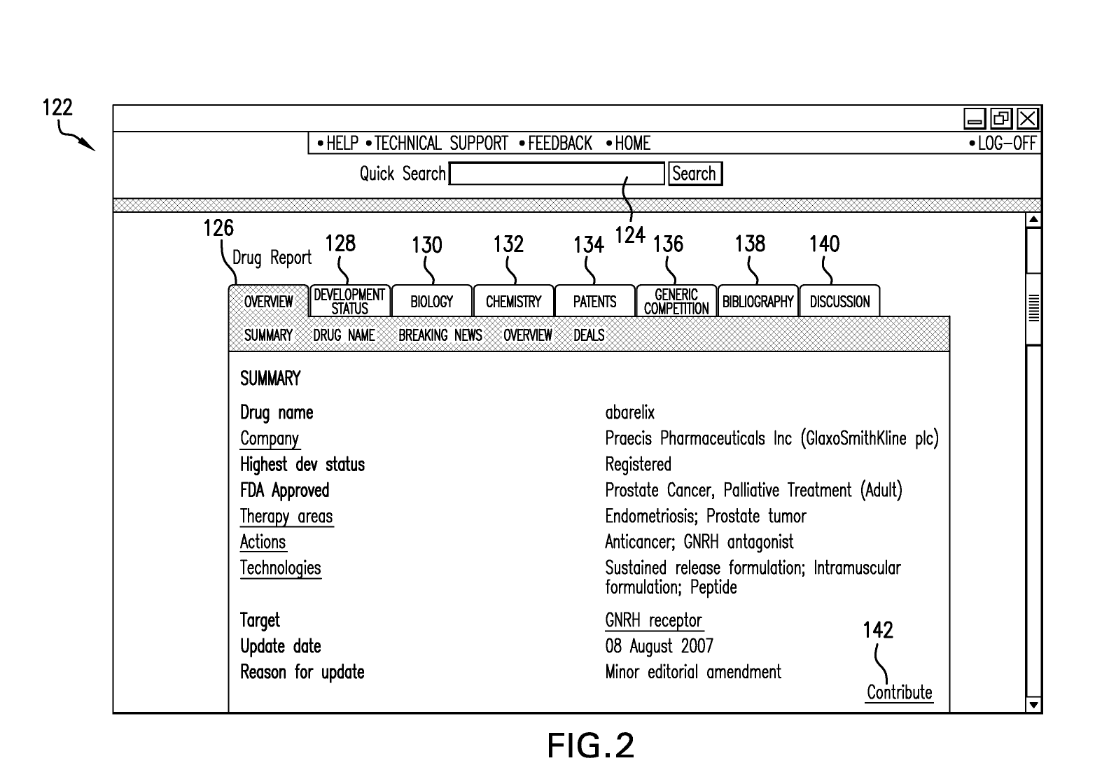

FIG. 2 illustrates a portion of secure portal 120, showing an exemplary drug report page 122. Each page of secure portal 120 includes a search field 124 that allows a user to quickly search for specific information. Search field 124 enables a user to search for specific drugs/compounds, patents, companies, targets, authors/inventors, literature, and news titles across therapy areas and technology indexes. Drug report page 122 may also include a plurality of tabs allowing a user to access different information relating to the specific drug being displayed on drug report page 122. Drug report page 122 may include an overview tab 126, a development status tab 128, a biology tab 130, a chemistry tab 132, a patents tab 134, a generic competition tab 136, a bibliography tab 138, and a discussion tab 140.

Overview tab 126 provides basic information about a specific drug, such as the drug name, the company that produces the drug, and the areas for which the drug has been approved by governmental or regulatory agencies such as the Federal Drug Administration. Development status tab 128 provides access to scientific, commercial, and financial information about the featured drug. Biology tab 130 and chemistry tab 132 provide information regarding the chemical and biological structure of the drug. Patents tab 134 provides access to information on intellectual property associated with the drug, including patents. Selecting patent tab 134 may also provide additional information regarding the related patents, including who owns the patents and whether the patents have been licensed. This information allows a user to follow the full story of a pharmaceutical invention from patent publication to expiration and beyond. Generic competition tab 136 provides news and information regarding companies that are producing generic versions of the selected drug. Bibliography tab 138 provides access to scientific literature such as articles and abstracts, as well as news that relates to the selected drug. Discussion tab 140 allows a user to view what other users of system 100 are saying about the selected drug and also allows a user to contribute to the discussion. FIG. 2 illustrates an example of a drug report page 122 for the drug abarelix, with overview tab 126 selected. As shown, a user can view at a glance important information regarding the drug and use the other tabs to view more in-depth information about the drug.

As indicated previously, database 102 may be a proprietary database. As such, the content of database 102 will be controlled and authenticated by a content provider or editor. In one exemplary embodiment, the content provider is a corporation, however, the content provider could also be any other entity or person who has control over the information stored in database 102 and who determines which users may be granted access to view the proprietary information within the database. Editor content module 114 running on server 104 interfaces with database 102 to provide the editor controlled content to users via network 108. For purposes of this disclosure, any information within the database that is provided by the editor is termed editor-generated content. In other words, editor-generated content is any content that was not submitted by a user of system 100.

System 100 also allows individual users to contribute to the information present in database 102. Each individual user of system 100 may have information that is not known or unavailabe to the editor of database 102. For example, a small company pursuing research and development of a drug might have information that is not available outside the company. A user of system 100 who is also an employee of the small company may wish to include this information in database 102. By allowing users to contribute to the information in database 102, system 100 is able to harness the collective intelligence of its users and enhance the value of the information provided. User contributions may increase the number of drugs covered in database 102 and lead to more timely updates of drug details and other information.

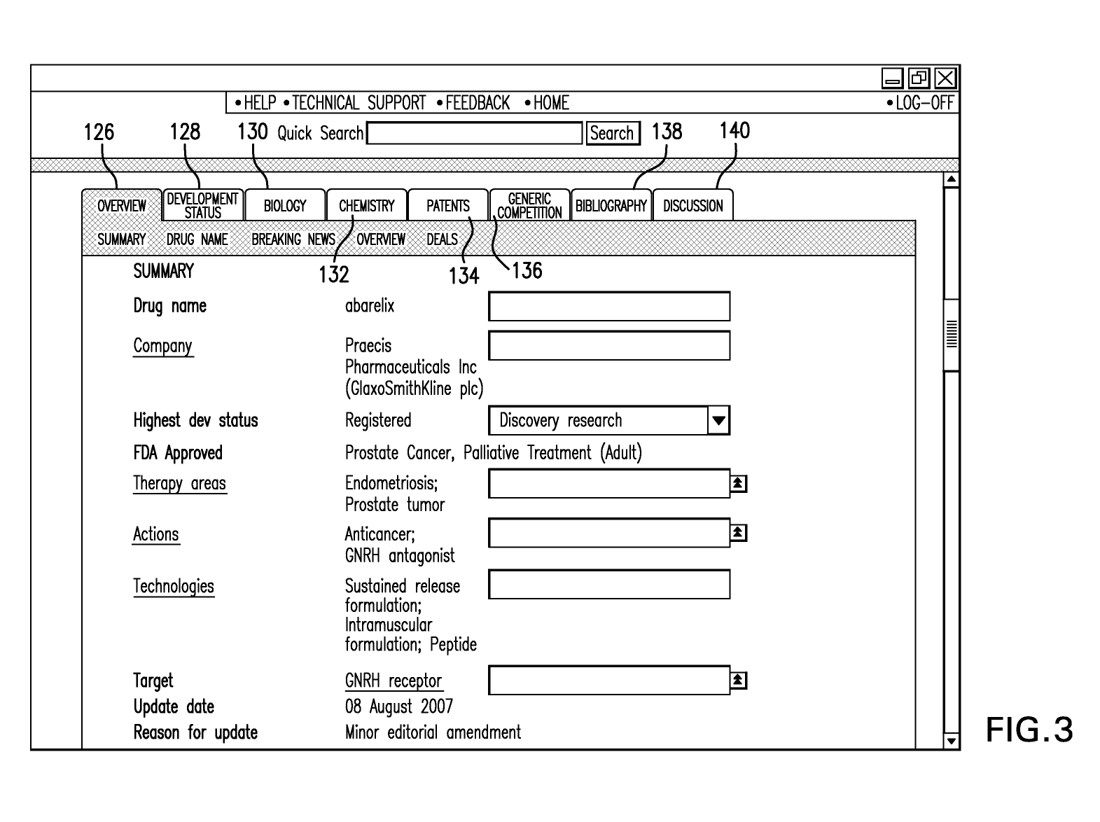

As shown in FIG. 2, each drug report page 122 may include a contribute link 142. Selecting contribute link 142 will call up an interface that allows the user to add information to the drug report. FIG. 3 illustrates one example of how this may be implemented in the overview portion of the drug report page 122. As shown in FIG. 3, once contribute link 142 is selected, data fields and/or drop down menus may appear that allow the user to enter new information relating to each of the facts listed on the page. For example, if the user is aware of additional names of the drug, or different therapy areas in which the drug is used, this information could be entered. User content module 112 running on server 104 interfaces with clients 106 to receive user-generated content and store that content in database 102. Similar links allowing users of system 102 to contribute information to any of the pages accessible through secure portal 120 may also be present.

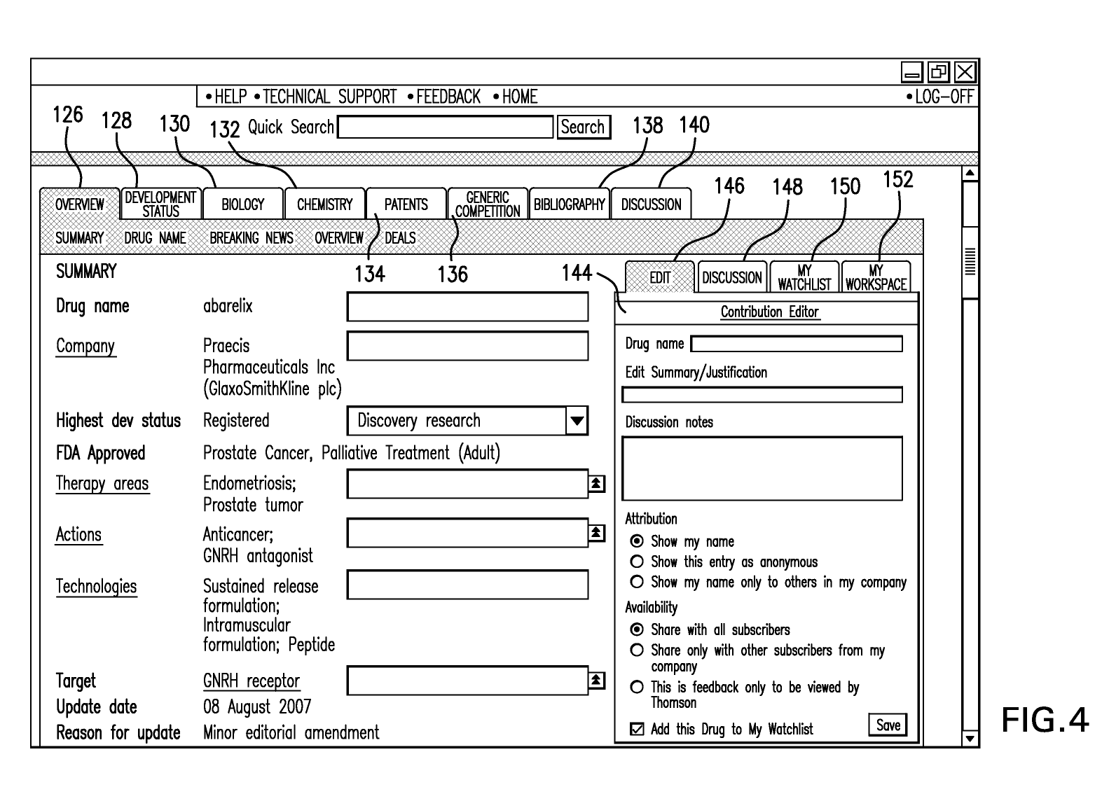

System 100 may include a wide variety of tools to facilitate entry of user-generated content as well as collaboration between users. As shown in FIG. 4, selecting contribute link 142 may call up a contribution editor 144. Contribution editor 144 may include an edit tab 146, a discussion tab 148, a my watchlist tab 150, and a my workspace tab 152.

In one exemplary embodiment, the user can control the extent of the availability of the user-generated content he or she submits. As shown in FIG. 4, contribution editor 144 may include functionality for selecting the attribution level and availability level of the user-generated content within edit tab 146. For example, in regard to attribution, a user may be given the option of showing the user's name with the content, showing the user's name with the content only to other users within the same company, or simply showing the user-generated content as being anonymously contributed. Secure portal 120 may also include functionality that allows a user to create custom groups by inviting other users to participate. The user-generated content could then be shared with members of the group. Regarding availability, a user may designate that the user-generated content be shared with all other users or subscribers of system 100, with only other user from the same company or other group, or only with the content provider, that is, the editor of the database. Contribution editor 144 may also include functionality for entering a drug name, for entering a summary or justification of the edit being made, and for entering discussion notes.

Contribution editor 144 may also include functionality for adding a drug of interest to a watchlist customized by the user. Selecting the my watchlist tab 150 from within contribution editor 144 will allow the user to view the drugs or other entries on the watchlist with links to further information and updates about each of the drugs or entries. System 100 may also include functionality that provides the user with a notification by email or other communication means when a change has been made to the information regarding any of the drugs on the user's watchlist.

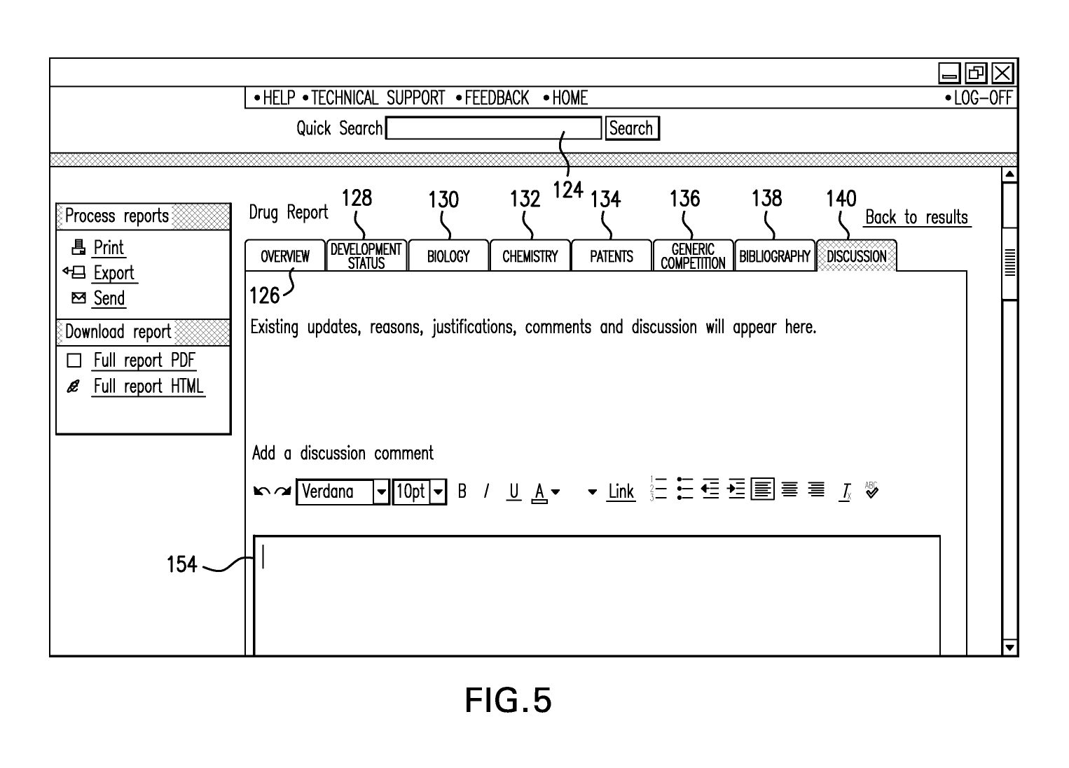

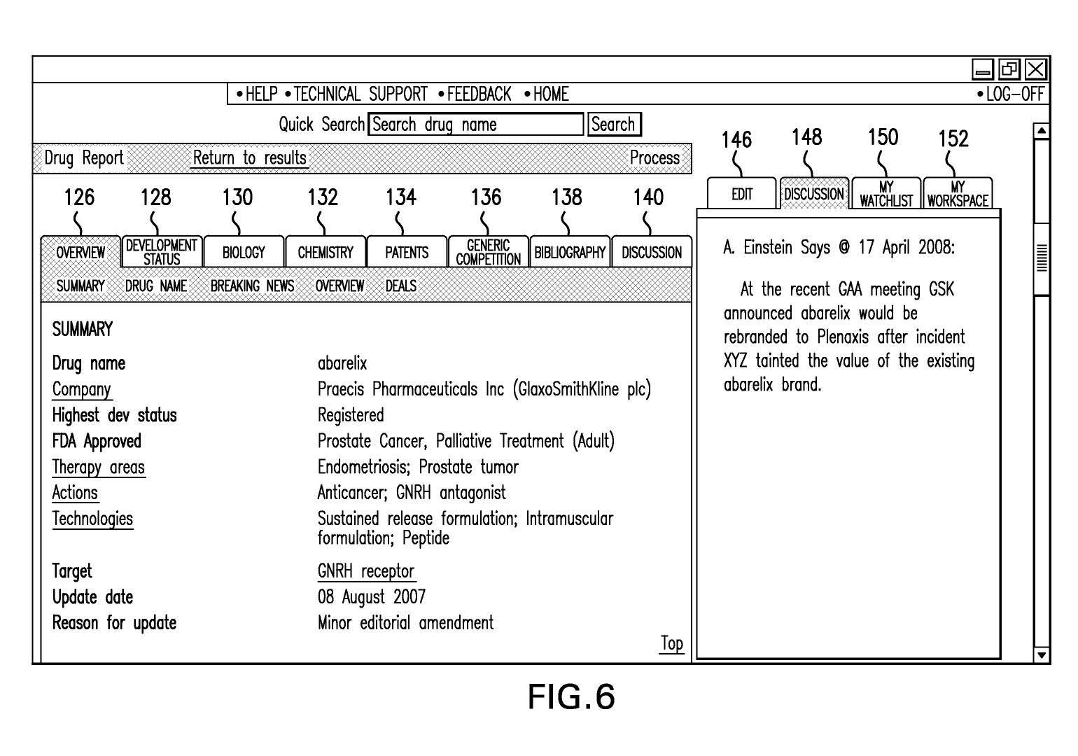

FIG. 5 provides an additional illustration as to how comments can be added to an existing drug report page 122 and posted for viewing, either by all users of system 100 or the group of users selected by the user. As shown in FIG. 5, Selecting discussion tab 140 on drug report page 122 allows a user to access a word processor 154, which may include a field for entering text as well as functionality for formatting the text that has been entered. Selecting discussion tab 140 will also allow a user to view existing updates, comments, and discussion from other users regarding the selected drug. Alternatively, a user may be able to add comments or view comments of others by selecting discussion tab 148 from within contribution editor 144. FIG. 6 provides an illustration of how comments of other users could be viewed from within contribution editor 144.

System 100 provides additional functionality to harness the collective intelligence of its users and enhance the overall usefulness of the data present in the system. By selecting the my workspace tab 152 from within contribution editor 144, the user will be able to access a personalized workspace where he or she can save searches and reports and set up multiple personal report folders to store drug reports and other information, with the information being updated automatically when new content arrives. The user may also be able to edit saved results and comments, as well as email, export, or otherwise share all or a portion of the content from within the user's personal workspace. System 100 also provides for the creation of virtual collaboration space, where relevant information can be shared instantly between different functions, groups, and locations within a company or other predefined group.

One of the challenges in integrating user-generated content with editor-generated content is filtering out the noise and ensuring that the user-generated content is of sufficient quality to be useful to other users and to add to, rather than detract from, the editor-generated content. In one preferred embodiment, system 100 includes automated tools for validating user-generated content. Unlike Wikipedia™, a collaboratively written encyclopedia to which any person can contribute, system 100 requires at least some form of validation from the system before the user-generated content will be displayed along with the editor-generated content. Because human review of each piece of user-generated content may not be feasible, system 100 may be configured to automatically provide a validation of user generated content using validation module 116 running on server 104.

When a user of system 100 enters data through secure portal 120, the data is sent to validation module 116. In one exemplary embodiment, validation module 116 receives the user-generated content and sends the user-generated content to the user interface module 112, where the user-generated content is then displayed in addition to the editor-generated content, that is, the content that has been authorized and validated by the editor. User interface module 110 may be configured to display the user-generated content in a way that clearly distinguishes it from the editor-generated content, such as by color or font differentiation, or by showing the user-generated content in a separate text box or window. The user-generated content may also be displayed such that other users who can view the content can indicate whether they agree or disagree with the posted user-generated content.

In another exemplary embodiment, validation module 116 may monitor the number of other users of system 100 that have submitted the same or similar content, and use statistical analysis to determine a probability that the user-generated content is accurate. The user-generated content would then only be published if the probability that the content is accurate meets a certain threshold. This threshold for accuracy could be set by a system administrator of system 100, authorized by the editor company. For example, a system administrator could determine that the user-generated content would be deemed valid if a certain number of users submitted the same content. Once the user-generated content has been deemed valid, the content could either be added to database 102 and shown to other users as valid, or it could be put at the top of a list of content that would be sent to the editor company for priority validation.

In another exemplary embodiment, validation module 116 works with user interface module 110 to publish the user-generated content along with an indicator of the probability of accuracy of the content. This indicator could be a color coded graphic, a percentage, or any other suitable indicator. Input from other users regarding whether they believe the content is accurate may also be taken into account by validation module 116 in determining the probability of accuracy.

System 100 may also include functionality allowing a user to rate other users of the system based on the quality of submitted user-generated content. Validation module 116 may include these ratings in the algorithms that determine the probability of accuracy of any given user-generated content. In addition, validation module 116 may utilize information from a user's profile stored within system 100. Validation module 116 may cull information from database 102 to determine whether the user is an expert in the field, by cross referencing publications written by the user and the number of citations to the user's work that exist in other publications within the database. Validation module 116 may take into account these expert ratings, as well as ratings submitted from other users when determining the probability that any given user-generated content is accurate.

As an example, user-generated content submitted by a user who is known to be an expert in a certain field, has published many papers, conducted clinical trials, and been heavily cited by his peers, will be given a greater probability of accuracy. The probability of accuracy will also increase if other users of system 100 have provided high ratings to the content previously submitted by the user. Biographical and education information available in database 102 regarding the user will also be taken into account by validation module 116. If it is determined that the user is submitting user-generated content that is outside of his or her scope of expertise, the probability of accuracy may be diminished by a pre-determined degree.

System 100 may also include functionality for detecting potential bias in user-generated content. Bias detection module 118 works in conjunction with validation module 116 to determine whether potential bias exists in the user-generated content. Each user of system 100 must create a user profile. This user profile may contain biographical data for each individual user, including companies they currently work for or have worked for in the past, schools attended, and other pertinent information. Bias detection module 118 determines whether any part of the user's profile indicates that the user-generated content may be biased. Bias detection module 118 may determine relationships between individuals, companies, or other entities to detect possible biases. For example, if a user who is known to work for company A submits a negative comment about a drug produced by rival company B, this user-generated content may be flagged for potential bias. The presence of potential bias may not automatically prevent the user-generated content from being displayed through secure portal 120. Any content that is deemed to be potentially biased may either be shown with an indicator that potential bias may exists, or, alternatively, the potential bias may be taken into account by validation module 116 in determining the probability of accuracy of the user-generated content. Additionally, system 100 may permit a user of system 100 to indicate whether the user suspects bias in the content generated by another user by selecting a checkbox, a link, or by other means.

Secure portal 120 of system 100 may also include functionality that allows for social bookmarking. Social bookmarking has been widely used on various Internet sites to allow users to store, organize, tag, search, and manage links to web pages. Secure portal 120 may provide access to a collaboration module 119 running on server 104 that includes functionality for storing, organizing, searching, and managing links to content within database 102. For example, selecting the my workspace tab 152 from within contribution editor 144 may provide a user with access to a personal workspace where the user can store and organize content from database 102 as well as from sources external to database 102. Secure portal 120 may include functionality that allows users to tag content within the database 102 with keywords or other metadata describing the content. Users may also bookmark an external website or other document and associate the website or document anywhere within database 102. For example, a user could read an article on a drug on a website external to database 102 and subsequently link or associate the article with the entry for the same drug in database 102. The user could also flag the entry, or any reference filed with the entry, as interesting and additionally provide comments on the entry.

In one exemplary embodiment, each individual user of secure portal 120 would determine which content in the user's personal workspace would be shared. A user may elect to share the content will all users, with only those users within the same company, or with another group defined by the user. The social bookmarking function can be a powerful means for users to share which companies, drugs, targets, mechanisms, and the like are of interest and why they are of interest.

System 100 may also include an open portal 156 as part of user interface module 110. Open portal 156 is a website that is closely affiliated with the content of database 102, but that is free and does not require a subscription. Open portal 156 would allow users who do not have access to secure portal 120 and the editor-generated content of database 102 to view and comment on the user-generated content and shared social bookmark content produced by users of secure portal 120. Open portal 156 may run on a separate server computer 158, as shown in FIG. 1, or alternatively, open portal 156 may reside on server 104. Open portal 156 may include a collaboration module 160 interfacing with the collaboration module 119 running on server 104. System 100 may also include functionality for facilitating sharing of user-generated content to other websites. For example, when a user posts a comment on a drug within secure portal 120, the user may be given the option of simultaneously posting the user-generated content to an external blog or other website of the user's choice. User-generated content submitted by a user while in secure portal 120 may also be posted to the open portal 156 at the user's option. Users of open portal 156 will thus be able to view all user-generated content that has been shared, but would only have access to the editor-generated content of database 102 if they subscribed and accessed the content through secure portal 120.

The present invention, as described above and shown in the drawings, provides for systems and methods for integrating user-generated content with proprietary content in a database. It will be apparent to those skilled in the art that various modifications and variations can be made to the systems and methods of the present invention without departing from the scope of the invention as outlined in the appended claims and their equivalents.

The invention claimed is:

1. A system for managing and displaying collaborative content, comprising:
a database storing editor-generated content and user-generated content;
a server interfacing with the database;
a display device connected to the server;
a user interface module running on the sever, the user interface module being configured to receive input from a user and to display content from the database on the display device;
an editor content module interfacing with the database and configured to display the editor-generated content on the display device;
a user content module configured to receive the user input from the user interface module and display the user input as user-generated content on the display device;
a validation module interfacing with the user content module, wherein the validation module is configured to verify the accuracy of the user-generated content; and
a bias detection module interfacing with the user content module, wherein the bias detection module is configured to detect bias in the user-generated content.

2. The system of claim 1, wherein the user interface module is configured to display the user-generated content simultaneously with corresponding editor-generated content.

3. The system of claim 1, wherein the validation module runs a statistical analysis to automatically determine the probability that the user-generated content is accurate.

4. The system of claim 3, wherein the validation module is configured to display an indication of the probability that the user-generated content is accurate along with the user-generated content.

5. The system of claim 1, wherein the user interface module is configured to allow the user to securely login to the system and create and store a user profile in the system.

6. The system of claim 5, wherein the user interface module is configured to allow the user to determine whether the user-generated content will be publicly associated with the user or published as anonymous user-generated content.

7. The system of claim 5, wherein the user interface module is configured to allow the user to selectively determine who can view the content.

8. The system of claim 5, wherein the user interface module is configured to allow a first user to submit a rating of the user-generated content of a second user.

9. The system of claim 8, wherein the validation module uses the rating of the first user as a part of the validation process of the user-generated content submitted by the second user.

10. The system of claim 5, wherein the bias detection module is configured to use the user profile data stored in the system to determine bias.

11. The system of claim 10, wherein the user profile data includes the name of the user and information about the user's present and past employers.

12. The system of claim 1, further comprising a collaboration module interfacing with the user interface module, wherein the collaboration module is configured to allow the user to bookmark external content and link the external content to at least one of editor-generated and user-generated content in the database.

13. The system of claim 12, wherein the collaboration module is configured to allow the user to share at least one of the external content, the user-generated content, and the editor-generated content with other users of the system.

14. The system of claim 13, wherein the collaboration module is configured to allow a user to submit comments concerning at least one of the editor-generated content, the user-generated content, and the external content.

15. The system of claim 1, wherein the database comprises a pharmaceutical database.

16. A computer-implemented method of managing and displaying collaborative content, comprising:
providing a database storing editor-generated content and user-generated content;
providing a server interfacing with the database;
providing a display device connected to the server;
receiving input in the form of user-generated content from a user;
validating the accuracy of the user-generated content using the server;
detecting the presence of potential bias in the user-generated content using the server; and
displaying the editor generated content and the user-generated content together on the display device;
wherein the display of the user-generated content includes an indication of the probability of accuracy of the user-generated content and the probability of bias in the user-generated content.

17. The method of claim 16, wherein the step of validating the accuracy of the user-generated content using the server comprises running a statistical analysis to automatically determine the probability that the user-generated content is accurate.

18. The method of claim 17, further comprising the step of displaying an indication of the probability that the user-generated content is accurate along with the user-generated content.

19. The method of claim 16, wherein the step of detecting the presence of potential bias includes using data stored in a secure user profile within the database.

20. The method of claims 16, further comprising allowing the user to bookmark external content and link the content to at least one of the editor-generated and the user-generated content in the database.
